(19) United States
(12) Patent Application Publication
(10) Pub. No.: US 2015/0276162 A1
(43) Pub. Date: Oct. 1, 2015

(54) VEHICLE LAMP

(71) Applicant: TOYOTA JIDOSHA KABUSHIKI KAISHA, Toyota-shi (JP)

(72) Inventor: Yasushi SHIBUYA, Okazaki-shi (JP)

(21) Appl. No.: 14/665,446

(22) Filed: Mar. 23, 2015

(30) Foreign Application Priority Data
Mar. 28, 2014 (JP) 2014-068030

(51) Int. Cl. F21S 8/10

(52) U.S. Cl. CPC F21S 48/234; F21S 48/00; F21W 2101/14

(57) ABSTRACT

A vehicle lamp including: a light source; a light guiding member configured by elongated member with light transmitting properties, and has light from light source incident through one length direction end face and emits light from light source from an emission face running along length direction; plural prism portions provided on an opposite side of light guiding member from emission face, that are disposed in row along length direction, and reflect light from light source incident to light guiding member toward emission face; circular arc shaped section formed on emission face side of light guiding member, and is configured with circular arc shaped cross-section in a direction orthogonal to light guiding member length direction; and a polygonal shaped section is formed on the prism portion side of light guiding member, and is configured with a polygonal shaped cross-section in a direction orthogonal to light guiding member length direction.

### CROSS-REFERENCE TO RELATED APPLICATION

This application is based upon and claims the benefit of priority of the prior Japanese Patent Application No. 2014-068030, filed on Mar. 28, 2014, the entire contents of which are incorporated herein by reference.

### FIELD

The embodiments discussed herein are related to a vehicle lamp.

### BACKGROUND

Patent Document 1 (Japanese Patent Application Laid-Open (JP-A) No. 2013-045662) describes a vehicle lamp including a light guiding lens (light guiding member) extending in a direction inclined with respect to a vehicle front-rear direction, and LEDs serving as light sources respectively disposed facing a rear end and a front end of the light guiding lens. A back face of the light guiding lens is provided with a row of lens cuts running along the length direction. In this vehicle lamp, light emitted from the rear end side LED and incident inside the light guiding lens through the rear end of the light guiding lens is internally reflected toward the front by the lens cuts, and light emitted from the front end side LED is incident inside the light guiding lens and then internally reflected toward the front by the lens cuts. Note that the structure of this vehicle lamp is described in Patent Document 2 (JP-A No. 2013-045671).

In the vehicle lamp described in Patent Document 1 (JP-A No. 2013-045662), a light emitting face of the light guiding lens tends to be brighter at positions near to the LEDs than the light emitting face of the light guiding lens at positions further away from the LEDs, and it is possible that a brightness difference may arise depending on the position in the length direction of the light guiding lens. There is accordingly room for improvement in terms of obtaining more even lighting along the length direction of the light guiding lens.

In consideration of the above circumstances, an object of the present invention is to obtain a vehicle lamp capable of more even lighting along the length direction of a light guiding member.

### SUMMARY

A vehicle lamp of a first aspect includes: a light source; a light guiding member that is configured by an elongated member with light transmitting properties, at which light from the light source is incident through one length direction end face, and that emits light from the light source from an emission face running along the length direction; plural prism portions that are provided on an opposite side of the light guiding member from the emission face, that are disposed in a row along the length direction, and that reflect light from the light source that is incident to the light guiding member toward the emission face; a circular arc shaped section that is formed on the emission face side of the light guiding member, and that is configured with a circular arc shaped cross-section in a direction orthogonal to the light guiding member length direction; and a polygon shaped section that is formed on the prism portion side of the light guiding member, and that is configured with a polygon shaped cross-section in a direction orthogonal to the light guiding member length direction.

According to the vehicle lamp of the first aspect, the light from the light source is incident through the one length direction end face of the light guiding member that has light transmitting properties. The plural prism portions are provided along the length direction of the light guiding member on the opposite side to the emission face, and are disposed in a row along the length direction. The light from the light source incident to the light guiding member is reflected toward the emission face of the light guiding member by the plural prism portions. Light is accordingly emitted from the emission face of the light guiding member. Note that the circular arc shaped section configured with a circular arc shaped cross-section in a direction orthogonal to the light guiding member length direction is formed on the emission face side of the light guiding member. Moreover, the polygon shaped section configured with a polygonal shaped cross-section in a direction orthogonal to the light guiding member length direction is formed on the prism portion side of the light guiding member. Light from the light source is accordingly guided in the length direction of the light guiding member toward the far side to the light source while being spread by the polygon shaped section of the light guiding member, enabling light to be concentrated at the circular arc shaped section of the light guiding member. This thereby enables light emitted from the light source to be made more uniform across the cross-section in the direction orthogonal to the light guiding member length direction, and also enables light emitted from the light source to be efficiently transmitted by the light guiding member.

A vehicle lamp of a second aspect is the vehicle lamp of the first aspect, wherein the plural prism portions are configured by plural projections projecting out toward an outer side from a face of the polygon shaped section of the light guiding member on the opposite side from the emission face.

According to the vehicle lamp of the second aspect, the plural prism portions are configured by the plural projections projecting out toward the outside from the face of the polygon shaped section of the light guiding member on the opposite side to the emission face. Light from the light source incident to the light guiding member is accordingly reflected by the plural prism portions projecting out toward the outside from the face of the polygon shaped section of the light guiding member on the opposite side to the emission face, thereby enabling the light from the light source to be transmitted further along the length direction of the light guiding member. Attenuation of light incident from the light source accompanying guidance of the light in the length direction of the light guiding member is accordingly suppressed in comparison to when plural prism portions are disposed within the cross-section in the direction orthogonal to the light guiding member length direction. This efficiently enables substantially even lighting along the length direction of the light guiding member.

A vehicle lamp of a third aspect is the vehicle lamp of the first aspect, wherein the polygon shaped section is configured including a location at which the cross-section is a polygonal shape of six or more sides that has been cut in half as viewed in cross-section from the side.

According to the vehicle lamp of the third aspect, the polygon shaped section is configured including the location where the cross-section is a polygonal shape of six or more sides that has been cut in half as viewed in cross-section from the side. Light from the light source can accordingly be guided along the length direction of the light guiding member toward the far side to the light source while being effectively spread by the polygon shaped section of the light guiding member.

A vehicle lamp of a fourth aspect is the vehicle lamp of the third aspect, wherein the circular arc shaped section is configured by a first location at which the cross-section is semicircle shaped as viewed in cross-section from the side, and the polygon shaped section includes a second location at which the cross-section is a hexagonal shape that has been cut in half as viewed in cross-section from the side, and a connection portion connecting between the second location and the circular arc shaped section.

According to the vehicle lamp of the fourth aspect, the circular arc shaped section is configured by the first location where the cross-section is semicircle shaped as viewed in cross-section from the side, and the polygon shaped section includes the second location where the cross-section is a hexagonal shape that has been cut in half as viewed in cross-section from the side, and the connection portion connecting between the second location and the circular arc shaped section. Light from the light source can accordingly be guided along the length direction of the light guiding member toward the far side to the light source while being effectively spread by the polygon shaped section of the light guiding member, enabling light to be more effectively concentrated on the circular arc shaped section of the light guiding member.

A vehicle lamp of a fifth aspect is the vehicle lamp of the second aspect, wherein the projections project out from the face of the polygon shaped section on the opposite side from the emission face toward the outer side in a triangular shape as viewed in plan view, and a face on a light source side of the projections is set at from 88° to 92° with respect to a optical axis of the light emitted from the light source and incident through the one length direction end face of the light guiding member, and a face on the opposite side of the projections from the light source is set at from 41° to 45° with respect to the optical axis of the light emitted from the light source and incident through the one length direction end face of the light guiding member.

According to the vehicle lamp of the fifth aspect, the projections project out from the face of the polygon shaped section on the opposite side of the light guiding member to the emission face toward the outside in a triangular shape as viewed in plan view. Note that the face on the light source side of the projections is set at from 88° to 92° with respect to the optical axis of light emitted from the light source and incident through one length direction end face of the light guiding member, and the face on the opposite side of the projections from the light source is set at from 41° to 45° with respect to the optical axis of light emitted from the light source and incident through one length direction end face of the light guiding member. This thereby enables light from the light source incident to the light guiding member to be more effectively concentrated on the emission face side that is on the opposite side to the projections in a direction orthogonal to the length direction of the light guiding member. This efficiently enables substantially even lighting along the length direction of the light guiding member.

A vehicle lamp of a sixth aspect is the vehicle lamp of the first aspect, wherein the light sources are respectively disposed at positions facing both length direction ends of the light guiding member, and the plurality of prism portions are formed symmetrically about a length direction central portion of the light guiding member so as to be arrayed toward both length direction end sides.

According to the vehicle lamp of the sixth aspect, the light sources are respectively disposed at positions facing both length direction ends of the light guiding member; and the plural prism portions are formed symmetrically about a length direction central portion of the light guiding member so as to head toward both length direction end sides. This thereby enables light from the light sources disposed at positions facing both length direction ends of the light guiding member to be emitted from the emission face along the length direction of the light guiding member, enabling substantially even lighting along the length direction of the light guiding member even more efficiently.

A vehicle lamp of a seventh aspect is the vehicle lamp of the first aspect, wherein the vehicle lamp is a high mount stop lamp provided at an upper portion side of a rear end section in a vehicle front-rear direction of a vehicle.

According to the vehicle lamp of the seventh aspect, the vehicle lamp is a high mount stop lamp provided at an upper portion side of a rear end section in the vehicle front-rear direction of a vehicle, and enables more even lighting along the length direction of the light guiding member as viewed from the rear side of the vehicle.

The vehicle lamp according to the present invention enables more even lighting along the length direction of a light guiding member.

### BRIEF DESCRIPTION OF DRAWINGS

FIG. 1 is a side view cross-section (an enlarged side view cross-section taken along line 1-1 in FIG. 2) illustrating configuration in the vicinity of a light guiding member employed in a vehicle lamp according to a first exemplary embodiment;

FIG. 2 is a plan view illustrating configuration in the vicinity of a light guiding member and light sources employed in the vehicle lamp illustrated in FIG. 1;

FIG. 3A is a plan view illustrating a vehicle lamp according to the first exemplary embodiment;

FIG. 3B is a plan view illustrating the vicinity of a length direction central portion of a light guiding member in a vehicle lamp according to the first exemplary embodiment;

FIG. 4 is a back face view illustrating the vehicle lamp illustrated in FIG. 3 as viewed from the rear of the vehicle;

FIG. 5 is an enlarged plan view illustrating light guidance paths of light incident to one length direction end face of a light guiding member from a light source of the vehicle lamp illustrated in FIG. 2;

FIG. 6A is an enlarged side view cross-section illustrating configuration of a light guiding member of a vehicle lamp according to a comparative example; and

FIG. 6B is an enlarged plan view cross-section illustrating configuration in the vicinity of one length direction end portion of a light guiding member, and a light source, in a vehicle lamp according to a comparative example.

### DESCRIPTION OF EMBODIMENTS

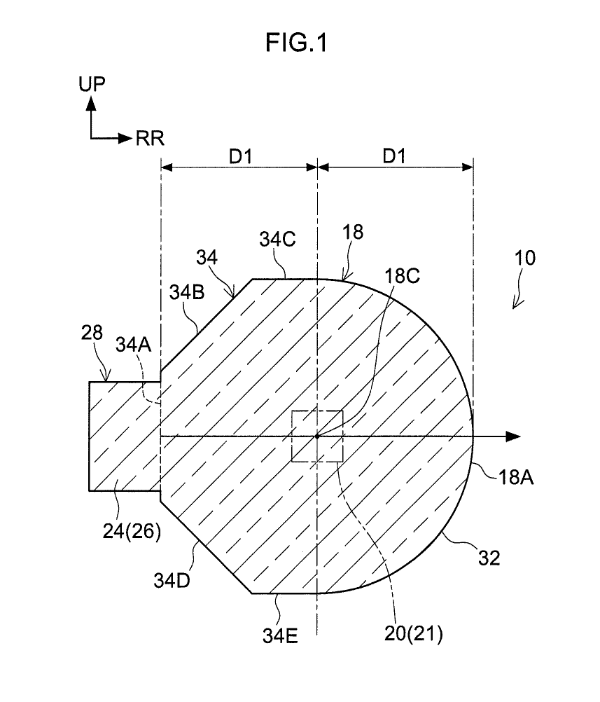

Explanation follows regarding a first exemplary embodiment of a vehicle lamp according to the present invention with reference to FIG. 1 to FIG. 5. In the drawings, the arrow RR indicates the rear side of a vehicle, the arrow UP indicates the vehicle upper side, and the arrow OUT indicates the vehicle width direction outside, as appropriate.

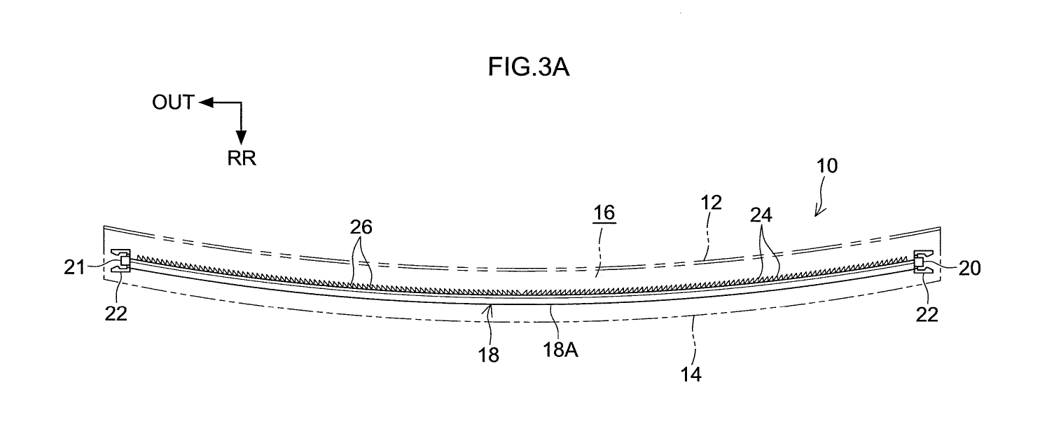

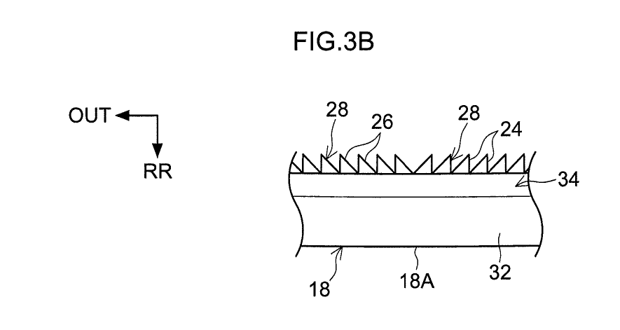

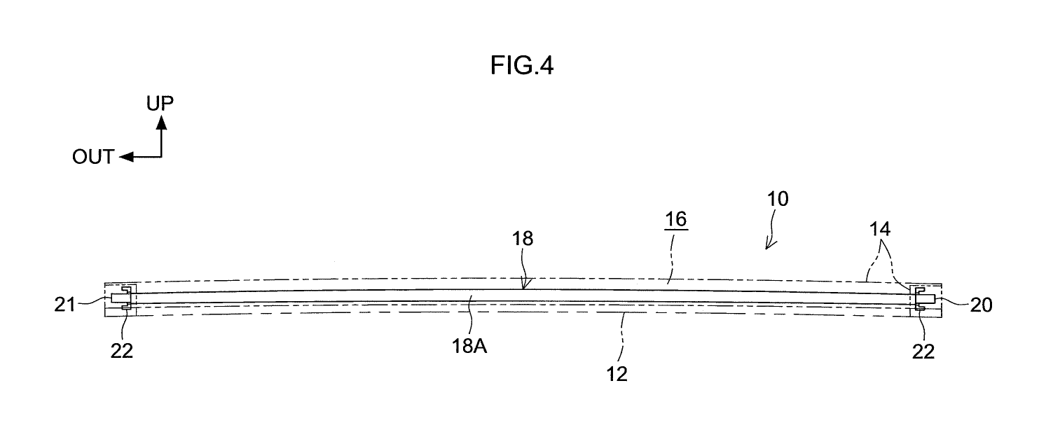

FIG. 3A is a plan view illustrating a vehicle lamp 10 of the present exemplary embodiment. FIG. 3B is an enlarged plan view illustrating the vicinity of a vehicle width direction central portion of a light guiding member 18 employed in the vehicle lamp 10. FIG. 4 is a back face view of the vehicle lamp 10, as viewed from the rear of the vehicle. The vehicle lamp 10 is a high mount stop lamp provided at an upper portion side of a rear end section of the vehicle (automobile) in the front-rear direction, and is disposed with length direction along the vehicle width direction.

As illustrated in FIG. 3A and FIG. 4, the vehicle lamp 10 includes housing 12 that is formed long and thin in the vehicle width direction and that has an opening facing toward the vehicle rear, and an outer lens 14 attached to the opening of the housing 12. Inside a lamp chamber 16 formed by the housing 12 and the outer lens 14, the vehicle lamp 10 also includes the light guiding member 18 disposed along the length direction of the housing 12, and a pair of left and right of light sources 20, 21 disposed at positions facing both vehicle width direction ends (both length direction ends) of the light guiding member 18 in the vehicle width direction. Inside the lamp chamber 16 formed by the housing 12 and the outer lens 14, the vehicle lamp 10 further includes a pair of left and right support bodies 22 that support the vehicle width direction outside ends of the light guiding member 18, and the light sources 20, 21 that face the width direction outside ends of the light guiding member 18.

The light guiding member 18 is configured by a solid elongated member with light transmitting properties, and extends in a substantially straight line shape along the vehicle width direction as viewed from the rear of the vehicle (see FIG. 4). The light guiding member 18 has a curved shape, with a vehicle width direction central portion projecting out further toward the vehicle rear side than the vehicle width direction ends as viewed from above the vehicle (see FIG. 3A).

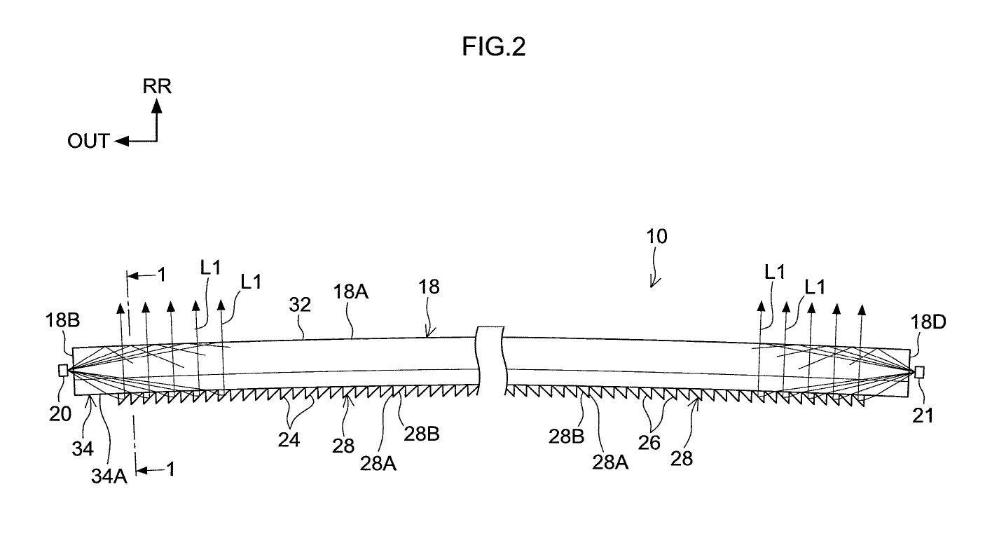

FIG. 2 is a plan view illustrating a configuration in the vicinity of the light guiding member 18 and the respective light sources 20, 21. As illustrated in FIG. 2, the light guiding member 18 is incident with light L1 from the light source 20 disposed on the left side in the vehicle width direction as viewed from the front of the vehicle (when viewing the vehicle face-on) at an end face on the left side in the vehicle width direction (one length direction end face) 18B facing the light source 20, and guides the light L1 toward the vehicle width direction central portion side. The light guiding member 18 is incident with light L1 from the light source 21 disposed on the right side in the vehicle width direction as viewed from the front of the vehicle at an end face on the right side in the vehicle width direction (one length direction end face) 18D facing the light source 21, and guides the light L1 toward the vehicle width direction central portion side. The light guiding member 18 reflects the light L1 incident from the light sources 20, 21 using plural prism portions 24, 26, described later, so as to emit the light L1 from an emission face (emission face along the length direction) 18A disposed facing the outer lens 14 (see FIG. 3A).

In the present exemplary embodiment, the emission face 18A of the light guiding member 18 faces toward the vehicle rear side, since the vehicle lamp 10 is a high mount stop lamp disposed at a rear end section in the vehicle front-rear direction.

As illustrated in FIG. 2, a face on the opposite side of the light guiding member 18 to the emission face 18A (a back face side with respect to the emission face of the light guiding member 18) is provided with the plural prism portions 24, 26 that reflect the light incident to the light guiding member 18 from the light sources 20, 21 toward the emission face 18A (see FIG. 3A). As viewed from the front of the vehicle, the plural prism portions 24 are disposed further toward the left side in the vehicle width direction than the vehicle width direction central portion of the light guiding member 18, and the plural prism portions 26 are disposed further toward the right side in the vehicle width direction than the vehicle width direction central portion of the light guiding member 18. The plural prism portions 24 and the plural prism portions 26 are disposed in respective rows along the length direction of the light guiding member 18, and are formed facing towards both vehicle width direction end sides with left-right symmetry about the vehicle width direction central portion (length direction central portion) of the light guiding member 18 (see FIG. 3B). In FIG. 3A, the plural prism portions 24, 26 provided to the light guiding member 18 are schematically illustrated larger than in reality for ease of comprehension. In reality, approximately 400 of the plural prism portions 24, 26 are provided along the length direction of the light guiding member 18, and they are smaller than those in the drawings.

As illustrated in FIG. 2, in the vehicle lamp 10, the light L1 incident to the light guiding member 18 from the light source 20 on the left side in the vehicle width direction as viewed from the front of the vehicle is reflected by the plural prism portions 24 on the left side in the vehicle width direction, such that the light L1 is emitted toward the vehicle rear from the emission face 18A of the light guiding member 18. Moreover, in the vehicle lamp 10, the light L1 incident to the light guiding member 18 from the light source 21 on the right side in the vehicle width direction as viewed from the front of the vehicle is reflected by the plural prism portions 26 on the right side in the vehicle width direction, such that the light L1 is emitted toward the vehicle rear from the from the emission face 18A of the light guiding member 18.

FIG. 1 is a side view cross-section taken along line 1-1 in FIG. 2, and illustrates configuration in the vicinity of the light guiding member 18. As illustrated in FIG. 1, the light guiding member 18 is provided with a circular arc shaped section 32, formed on the emission face 18A side, with a circular arc shaped cross-section taken in a direction orthogonal to the length direction, and a polygonal shaped section 34, formed on the side of the prism portions 24, 26, with a polygonal shaped cross-section taken in a direction orthogonal to the length direction. In the present exemplary embodiment, the circular arc shaped section 32 is configured with a substantially semicircular shaped cross-section profile as viewed in cross-section from the side of the vehicle, and is disposed on a rear half side of the light guiding member 18 in the vehicle front-rear direction. The polygonal shaped section 34 is configured including a location with a cross-section profile of a substantially hexagonal shape that has been cut roughly in half as viewed in cross-section from the side of the vehicle, and is disposed on a front half side of the light guiding member 18 in the vehicle front-rear direction. In the present exemplary embodiment, the polygonal shaped section 34 is configured by a location where a substantially regular octagonal shaped cross-section has been cut away along the vehicle up-down direction.

More specifically, the polygonal shaped section 34 includes a back face (a face on the opposite side to the emission face 18A) 34A disposed on the opposite side of the light guiding member 18 to the emission face 18A and disposed along the vehicle up-down direction (vertical direction), an inclined face 34B extending in an upward slope from an upper end of the back face 34A toward a vehicle diagonal rear side, and an inclined face 34D extending in a downward slope from a lower end of the back face 34A toward a vehicle diagonal rear side. The polygonal shaped section 34 further includes: an upper face 34C, serving as a connection portion, that extends from an upper end of the inclined face 34B toward the vehicle rear side, and that is connected to an upper portion of the circular arc shaped section 32; and a lower face 34E, serving as a connection portion, that extends from a lower end of the inclined face 34D toward the vehicle rear side, and that is connected to a lower portion of the circular arc shaped section 32.

As viewed in cross-section from the side of the vehicle, in the polygonal shaped section 34, the back face 34A, the inclined face 34B, and the inclined face 34D configure a location where a substantially hexagonal shape has been cut in half. The lengths of the back face 34A, the inclined face 34B, and the inclined face 34D are set substantially the same as each other. The back face 34A of the polygonal shaped section 34 is disposed on the front side of the light guiding member 18 in the vehicle front-rear direction. The upper face 34C and the lower face 34E are respectively joined to the substantially semicircular shape of the circular arc shaped section 32 at the upper face and the lower face of the in the vehicle up-down direction. In the present exemplary embodiment, a central portion 18C of the light guiding member 18 is disposed at a position from which a length D1 of the circular arc shaped section 32 in the vehicle front-rear direction is substantially the same as a length D1 of the polygonal shaped section 34 in the vehicle front-rear direction.

In the vehicle lamp 10, the circular arc shaped section 32 is formed to the light guiding member 18 on the emission face 18A side, and the polygonal shaped section 34 is formed to the light guiding member 18 on the side of the prism portions 24, 26. Light from the light sources 20, 21 is accordingly guided along the length direction of the light guiding member 18 from the light sources 20, 21 toward the far sides to the respective light sources 20, 21 while being spread by the polygonal shaped section 34 of the light guiding member 18, and the light is concentrated on the circular arc shaped section 32 of the light guiding member 18.

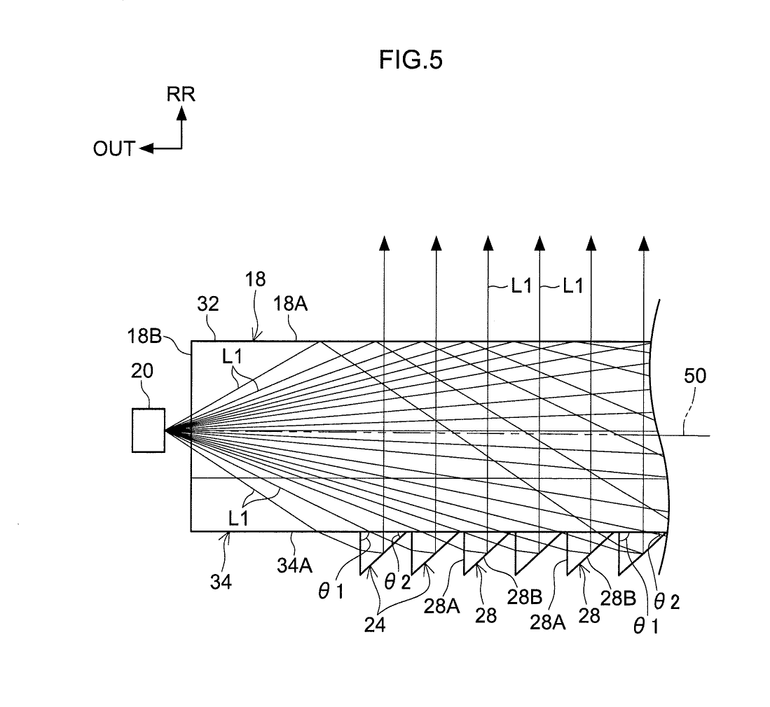

As viewed in cross-section from the side of the vehicle, the light sources 20, 21 at both vehicle width direction ends are respectively disposed at positions overlapping with the central portion 18C of the light guiding member 18. In the vehicle lamp 10 of the present exemplary embodiment, emission faces from which light is emitted from the light sources 20, 21 are disposed substantially parallel to the respective length direction end faces 18B, 18D of the light guiding member 18 (see FIG. 2 and FIG. 5). Moreover, in the vehicle lamp 10, an optical axis 50 of light emitted in a direction orthogonal to the emission faces of the light sources 20, 21 (see FIG. 5) is set so as to pass through the central portion 18C of the light guiding member 18 when the light is incident through the length direction end faces 18B, 18D of the light guiding member 18.

As illustrated in FIG. 2, the plural prism portions 24 are configured by plural projections 28 projecting out toward the outside from the back face 34A (the face on the opposite side to the emission face 18A) of the polygonal shaped section 34 of the light guiding member 18 (see FIG. 5). In plan view of the vehicle, the projections 28 project out in triangular shapes from the back face 34A of the polygonal shaped section 34 toward the outside. The plural prism portions 26 are also configured by the plural projections 28 projecting out toward the outside from the back face 34A of the polygonal shaped section 34 of the light guiding member 18. The projections 28 of the prism portions 26 and the projections 28 of the prism portions 24 are formed on both vehicle width direction sides of the light guiding member 18, with left-right symmetry about the vehicle width direction central portion (heading from the vehicle width direction central portion of the light guiding member 18 toward the vehicle width direction outside ends) (see FIG. 3B).

In the vehicle lamp 10, the light L1 incident to the light guiding member 18 from the light sources 20, 21 is reflected by the plural projections 28 projecting out toward the outside from the back face 34A of the polygonal shaped section 34 of the light guiding member 18. The light L1 from the light sources 20, 21 is accordingly transmitted (guided) further along the length direction of the light guiding member 18.

As illustrated in FIG. 5, the optical axis (optical axial center) 50 of light emitted from the light source 20 and incident through the length direction end face 18B of the light guiding member 18 is a straight line extending in a direction orthogonal to the emission face of the light source 20. In the vehicle lamp 10, in plan view of the vehicle, first faces 28A serving as faces on the light source 20 side of the projections 28 are set at approximately 90° with respect to the optical axis 50 of light emitted from the light source 20 and incident through the length direction end face 18B of the light guiding member 18. Moreover, in the vehicle lamp 10, in plan view of the vehicle, second faces 28B, serving as faces on the opposite side of the projections 28 to the light source 20, are set at approximately 43° with respect to the optical axis 50 of light emitted from the light source 20 and incident through the length direction end face 18B of the light guiding member 18. In other words, in a cross-section taken in plan view of the vehicle, an angle θ1 between the optical axis 50 and the first faces 28A on the light source 20 side of the projections 28 is set at approximately 90°, and an angle θ2 between the optical axis 50 and the second faces 28B on the opposite side of the projections 28 to the light source 20 is set at approximately 43°.

In plan view of the vehicle, the light guiding member 18 is configured with a curved shape in which the vehicle width direction central portion projects out further to the vehicle rear side than both vehicle width direction ends (see FIG. 3A). Accordingly, due to setting the angle θ1 between the optical axis 50 and the first faces 28A on the light source 20 side of the projections 28, and the angle θ2 between the optical axis 50 and the second faces 28B on the opposite side of the projections 28 to the light source 20, to the angles mentioned above, the external profiles (triangular shapes) of the projections 28 vary slightly in shape along the length direction of the light guiding member 18 in plan view of the vehicle.

In the vehicle lamp 10, the angle θ1 between the optical axis 50 and the first faces 28A on the light source 20 side of the projections 28 is not limited to 90°, and may be varied. Moreover, the angle θ2 between the optical axis 50 and the second faces 28B on the opposite side of the projections 28 to the light source 20 is not limited to 43°, and may be varied. In the vehicle lamp 10 of the present invention, the angle θ1 between the optical axis 50 and the first faces 28A on the light source 20 side of the projections 28 is preferably from 88° to 92°, is more preferably from 89° to 91°, and is most preferably 90°. The angle θ2 between the optical axis 50 and the second faces 28B on the opposite side of the projections 28 to the light source 20 is preferably from 41° to 45°, is more preferably from 42° to 44°, and is most preferably 43°.

As illustrated in FIG. 5, in the vehicle lamp 10, the light L1 emitted from the light source 20 on the left side in the vehicle width direction as viewed from the front of the vehicle is incident inside the light guiding member 18 through the end face 18B that faces the light source 20 on the vehicle width direction left side of the light guiding member 18. The light L1 incident inside the light guiding member 18 is internally reflected by the respective plural prism portions 24 formed to the back face 34A of the light guiding member 18 either directly, or after being internally reflected on the emission face 18A side of the light guiding member 18. When this occurs, the light L1 is internally reflected by the respective prism portions 24 after passing through the prism portion 24 that is adjacent on the left side in the vehicle width direction. The light L1 that has been internally reflected by the plural prism portions 24 is then emitted from the emission face 18A of the light guiding member 18 toward the vehicle rear.

More specifically, as illustrated in FIG. 5, in the vicinity of the end of the light guiding member 18 on the width direction left side as viewed from the front of the vehicle, the light L1 incident inside the light guiding member 18 is initially emitted from the back face 34A of the light guiding member 18 into a space external to the light guiding member 18, or initially emitted from the second face 28B of one of the prism portions 24 to the space external to the light guiding member 18, before the light L1 is incident again, through the first face 28A of the prism portion 24 adjacent on the vehicle width direction inside, and then the light L1 is internally reflected (totally reflected) by the second face 28B of that prism portion 24. Moreover, on the vehicle width direction inner side of the light guiding member 18 as viewed from the front of the vehicle, the light L1 incident inside the light guiding member 18 is internally reflected at the emission face 18A side of the light guiding member 18, after which it is emitted once from the second face 28B of one of the prism portions 24 to the space external to the light guiding member 18, and then the light L1 is incident again through the first face 28A of the prism portion 24 adjacent on the vehicle width direction inner side. The re-incident light L1 is then internally reflected by the second face 28B of that prism portion 24.

In the vehicle lamp 10, the angle θ1 between the optical axis 50 and the first faces 28A on the light source 20 side of the projections 28 is set at approximately 90°, and the angle θ2 between the optical axis 50 and the second faces 28B on the opposite side of the projections 28 to the light source 20 is set at approximately 43°. This thereby enables light incident to the light guiding member 18 from the light source 20 to be more effectively concentrated on the emission face 18A side that is opposite the projections 28 in a direction orthogonal to the length direction of the light guiding member 18.

If the angle θ1 between the optical axis 50 and the first faces 28A on the light source 20 side of the projections 28 is set outside the range of from 88° to 92°, and the angle θ2 between the optical axis 50 and the second faces 28B on the opposite side of the projections 28 to the light source 20 is set outside the range of from 41° to 45°, then there is a reduced effect of concentrating light on the emission face 18A side that is opposite the projections 28 in a direction orthogonal to the length direction of the light guiding member 18 when the light is reflected by the plural prism portions 24, 26.

As illustrated in FIG. 2, in the vehicle lamp 10, the light L1 emitted from the light source 21 on the right side in the vehicle width direction as viewed from the front of the vehicle is incident inside the light guiding member 18 through the end face 18D that faces the light source 21 on the vehicle width direction right side of the light guiding member 18. The plural prism portions 26 disposed on the vehicle width direction right side of the vehicle width direction central portion of the light guiding member 18 as viewed from the front of the vehicle are configured with left-right symmetry to the plural prism portions 24 disposed on the vehicle width direction left side of the light guiding member 18. The light L1 incident inside the light guiding member 18 is accordingly internally reflected by the respective plural prism portions 26 formed to the back face 34A of the light guiding member 18 either directly, or after being internally reflected on the emission face 18A side of the light guiding member 18. The light L1 is then emitted from the emission face 18A of the light guiding member 18 toward the rear of the vehicle.

Explanation follows regarding operation and advantageous effects of the present exemplary embodiment.

As illustrated in FIG. 2 etc., in the vehicle lamp 10, the light L1 from the light sources 20, 21 disposed at both vehicle width direction ends is incident through the length direction end faces 18B, 18D of the light guiding member 18 that face the respective light sources 20, 21. The plural prism portions 24, 26 are disposed in rows along the length direction on the opposite side to the emission face 18A that runs along the length direction of the light guiding member 18. The light L1 from the light source 20 on the left side in the vehicle width direction as viewed from the front of the vehicle that is incident to the end face 18B on the vehicle width direction left side of the light guiding member 18 is accordingly reflected toward the emission face 18A of the light guiding member 18 by the plural prism portions 24.

More specifically, as illustrated in FIG. 5, in the vicinity of the end of the light guiding member 18 on the vehicle width direction left side as viewed from the front of the vehicle, the light L1 incident inside the light guiding member 18 is initially emitted from the back face 34A of the light guiding member 18 into a space external to the light guiding member 18, or initially emitted from the second face 28B of one of the prism portions 24 to the space external to the light guiding member 18, before being incident again through the first face 28A of the prism portion 24 adjacent on the vehicle width direction inside. The light L1 is then internally reflected (totally reflected) by the second face 28B of that prism portion 24. Moreover, on the vehicle width direction inner side of the light guiding member 18, the light L1 incident inside the light guiding member 18 is internally reflected at the emission face 18A side of the light guiding member 18, after which it is emitted once from the second face 28B of one of the prism portions 24 to the space external to the light guiding member 18, and is then incident again through the first face 28A of the prism portion 24 adjacent on the vehicle width direction inner side. The re-incident light L1 is then internally reflected (totally reflected) by the second face 28B of that prism portion 24. The light L1 reflected by the second faces 28B of the plural prism portions 24 is accordingly emitted from the emission face 18A of the light guiding member 18 toward the rear of the vehicle.

The plural prism portions 24, 26 are formed with left-right symmetry, heading from the vehicle width direction central portion toward the vehicle width direction outside ends of the light guiding member 18. The light L1 incident from the light source 21 on the right side in the vehicle width direction to the end face 18D on the vehicle width direction right side of the light guiding member 18 as viewed from the front of the vehicle is accordingly internally reflected toward the emission face 18A of the light guiding member 18 by the plural prism portions 26, in a similar manner to that described above. The light L1 is accordingly emitted toward the rear of the vehicle from the emission face 18A that runs along the length direction of the light guiding member 18.

When this occurs, as illustrated in FIG. 1, the circular arc shaped section 32 configured with a circular arc shaped cross-section in the direction orthogonal to the length direction is formed to the light guiding member 18 on the emission face 18A side, and the polygonal shaped section 34 configured with a polygonal shaped cross-section in the direction orthogonal to the length direction is formed to the light guiding member 18 on the side of the prism portions 24, 26. This thereby enables the light L1 from the light sources 20, 21 to be guided along the length direction of the light guiding member 18 toward the far sides to the respective light sources 20, 21, while being spread by the polygonal shaped section 34 of the light guiding member 18, and enables the light to be concentrated at the circular arc shaped section 32 of the light guiding member 18. The light L1 emitted from the light sources 20, 21 can accordingly be made uniform across the cross-section in the direction orthogonal to the length direction of the light guiding member 18, and the light L1 emitted from the light sources 20, 21 can be efficiently transmitted (guided) by the light guiding member 18.

In the vehicle lamp 10, the plural prism portions 24, 26 are configured by the plural projections 28 that project out toward the outside from the back face 34A of the polygonal shaped section 34 of the light guiding member 18. Namely, light incident to the light guiding member 18 from the light sources 20, 21 is reflected by the plural projections 28 projecting out toward the outside from the back face 34A of the polygonal shaped section 34 of the light guiding member 18, thereby enabling the light L1 from the light sources 20, 21 to be transmitted (guided) further along the length direction of the light guiding member 18. Attenuation of the light L1 incident from the light sources 20, 21 accompanying guidance of the light along the length direction of the light guiding member 18 can accordingly be suppressed in comparison to when plural prism portions are disposed within a cross-section in a direction orthogonal to the length direction of a light guiding member, efficiently enabling substantially even lighting along the length direction of the light guiding member 18.

Moreover, in the vehicle lamp 10, as viewed in cross-section from the side of the vehicle, the circular arc shaped section 32 is configured at a location with a semicircular shaped cross-section. The polygonal shaped section 34 includes the location with a cross-section profile of a substantially hexagonal shape cut roughly in half as viewed in cross-section from the side of the vehicle, configured by the back face 34A, the inclined face 34B, and the inclined face 34D, and also includes the upper face 34C and the lower face 34E that respectively connect this location to the circular arc shaped section 32. Light from the light sources 20, 21 can accordingly be guided along the length direction of the light guiding member 18 toward the far sides to the respective light sources 20, 21, while being more effectively spread by the polygonal shaped section 34 of the light guiding member 18, and light can be more effectively concentrated on the circular arc shaped section 32 of the light guiding member 18.

In the vehicle lamp 10, in plan view of the vehicle, the projections 28 project out toward the outside in triangular shapes from the back face 34A of the polygonal shaped section 34 of the light guiding member 18. The relationship between the light source 20 on the left side in the vehicle width direction as viewed from the front of the vehicle, and the plural prism portions 24, is set such that the first faces 28A on the light source 20 side of the projections 28 is at approximately 90° to the optical axis 50 of the light L1 emitted from the light source 20 and incident through the length direction end face 18B of the light guiding member 18. Moreover, the second faces 28B on the opposite side of the projections 28 to the light source 20 are set at approximately 43° with respect to the optical axis 50 of the light L1 emitted from the light source 20 and incident through the length direction end face 18B of the light guiding member 18. Similarly, the relationship between the light source 21 on the right side in the vehicle width direction as viewed from the front of the vehicle and the plural prism portions 26 is set such that the first faces 28A on the light source 21 side of the projections 28 is at approximately 90° to the optical axis 50 of the light L1 emitted from the light source 21 and incident through the length direction end face 18D of the light guiding member 18. Moreover, the second faces 28B on the opposite side of the projections 28 to the light source 21 are set at approximately 43° with respect to the optical axis 50 of the light L1 emitted from the light source 21 and incident through the length direction end face 18D of the light guiding member 18.

This thereby enables the light L1 incident to the light guiding member 18 from the light sources 20, 21 to be more effectively concentrated on the emission face 18A side in a direction orthogonal to the length direction of the light guiding member 18. Namely, the light L1 can be emitted from the emission face 18A of the light guiding member 18 substantially straight toward the rear of the vehicle. This thereby enables substantially even lighting along the length direction of the light guiding member 18 even more efficiently.

In the vehicle lamp 10, the light sources 20, 21 are respectively disposed at positions facing both length direction ends (both vehicle width direction ends) of the light guiding member 18, and the plural prism portions 24, 26 are formed with left-right symmetry to each other, heading toward both length direction end sides at both vehicle width direction sides of the length direction central portion of the light guiding member 18. This thereby enables the light L1 from the light sources 20, 21 disposed at positions facing both length direction ends of the light guiding member 18 to be emitted from the emission face 18A that runs along the length direction of the light guiding member 18, and enables substantially even lighting along the length direction of the light guiding member 18 even more efficiently.

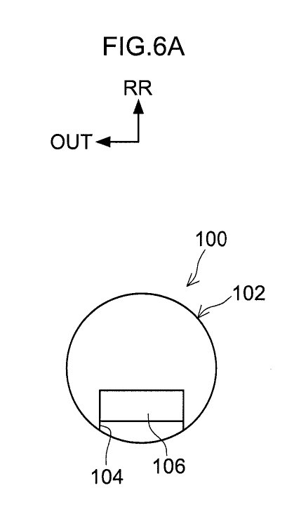

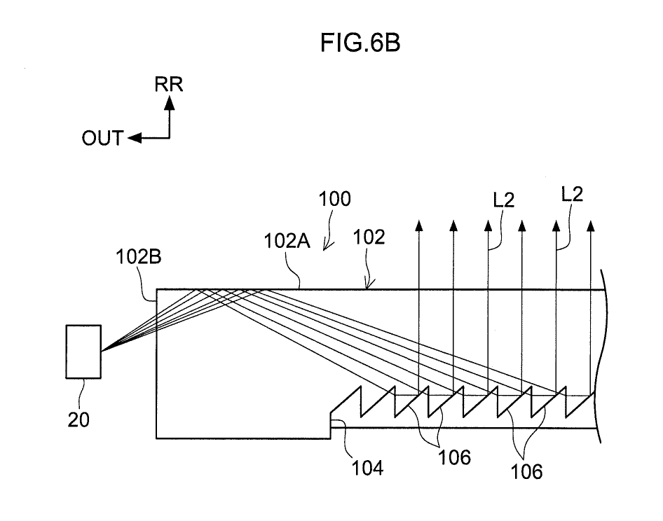

FIG. 6A is a side view cross-section illustrating a light guiding member 102 employed in a vehicle lamp 100 according to a comparative example. FIG. 6B is a plan view cross-section illustrating the vicinity of one vehicle width direction end of the light guiding member 102 employed in the vehicle lamp 100 according to the comparative example. As illustrated in FIG. 6A, the light guiding member 102 of the vehicle lamp 100 has a substantially circular columnar shape as viewed in cross-section from the side of the vehicle. As illustrated in FIG. 6A and FIG. 6B, a recess 104 that is a substantially rectangular shaped recess as viewed from the front of the vehicle is provided within the circular columnar shaped cross-section of the light guiding member 102. Plural prism portions 106 are provided to the recess 104 in a sawtooth formation along the length direction of the light guiding member 102. As viewed in a plan view cross-section of the vehicle, each of the prism portions 106 is formed in a substantially right-angled triangular shape.

In the thus configured vehicle lamp 100, light L2 from a light source 20 that is incident to an end face 102B on one end side in the length direction of the light guiding member 102 is internally reflected toward an emission face 102A of the light guiding member 102 by the plural prism portions 106 either directly, or after being internally reflected on the emission face 102A side of the light guiding member 102. The light L2 is accordingly emitted from the emission face 102A toward the rear of the vehicle.

Since the light guiding member 102 is formed in a substantially circular columnar shape as viewed in cross-section from the side of the vehicle, light is concentrated at a central portion of the cross-section. A higher brightness value can accordingly be obtained by disposing the plural prism portions 106 within the cross-section of the light guiding member 102.

However, in the vehicle lamp 100, the light L2 incident to the light guiding member 102 from the light source 20 is prone to attenuation accompanying guidance toward the vehicle width direction inside of the light guiding member 102. As viewed from the rear of the vehicle, in the vehicle lamp 100 a higher brightness value is therefore obtained for the light L2 emitted from the light guiding member 102 close to incidence from the light source 20. The brightness value of the light L2 emitted from the light guiding member 102 decreases further away from the light source 20, on the vehicle width direction inside. It is accordingly difficult to achieve substantially even lighting along the length direction of the light guiding member 102.

In contrast, in the vehicle lamp 10 of the present exemplary embodiment, the cross-section of the light guiding member 18 is formed with the circular arc shaped section 32 on the side of the emission face 18A, and the cross-section of the light guiding member 18 is formed with the polygonal shaped section 34 on the side of the prism portions 24, 26 (see FIG. 1). This thereby enables the light L1 from the light sources 20, 21 to be guided along the length direction of the light guiding member 18 toward the far sides to the respective light sources 20, 21 while being spread by the polygonal shaped section 34 of the light guiding member 18, and enables the light to be concentrated at the circular arc shaped section 32 of the light guiding member 18. The light L1 emitted from the light sources 20, 21 can accordingly be made uniform across the cross-section in the direction orthogonal to the length direction of the light guiding member 18, and the light L1 emitted from the light sources 20, 21 can be efficiently transmitted (guided) by the light guiding member 18.

In the vehicle lamp 10, the plural prism portions 24, 26 are configured by the plural projections 28 projecting out toward the outside from the back face 34A of the polygonal shaped section 34 in the light guiding member 18. Attenuation of light incident from the light sources 20, 21 accompanying guidance of the light along the length direction of the light guiding member 18 can accordingly be suppressed in comparison to in the configuration of the comparative example, in which the plural prism portions 106 are disposed within the cross-section of the light guiding member 102. This efficiently enables substantially even lighting along the length direction of the light guiding member 18.

Note that in the present exemplary embodiment, the polygonal shaped section 34 of the light guiding member 18 is configured including the location where a substantially hexagonal shaped cross-section has been cut in half substantially in the vehicle up-down direction as viewed in cross-section from the side of the vehicle. However, the present invention is not limited thereto. The polygonal shaped section of the light guiding member may be modified to a different shape. For example, the polygonal shaped section of the light guiding member is preferably configured including a location where a polygonal shaped cross-section with six or more sides is cut in half substantially in the vehicle up-down direction. In such cases, it is not desirable for the number of sides of the polygonal shaped portion of the polygonal shaped section to become too great, since this causes the shape to approach that of a circle. The polygonal shaped section of the light guiding member is therefore preferably configured including a location where a cross-section of a hexagonal shape or octagonal shape is cut in half in substantially the vehicle up-down direction.

In the present exemplary embodiment, the circular arc shaped section 32 of the light guiding member 18 is configured by the location with a substantially semicircular shape as viewed in cross-section from the side of the vehicle; however the present invention is not limited thereto. For example, the circular arc shaped section 32 of the light guiding member 18 may be modified to another circular arc shaped cross-section, such as a location including an elliptical shaped cross-section.

In the present exemplary embodiment, the plural prism portions 24, 26 are configured projecting out toward the outside of the polygonal shaped section 34 of the light guiding member 18; however the present invention is not limited thereto. For example, the plural prism portions 24, 26 may be provided within the cross-section of the polygonal shaped section 34 of the light guiding member 18.

In the present exemplary embodiment, explanation has been given regarding a case in which the vehicle lamp 10 is a high mount stop lamp provided at an upper portion side of a rear end section of the vehicle in the vehicle front-rear direction. However, the present invention is not limited thereto. For example, the vehicle lamp 10 can obtain similar operation and advantageous effects to those described above when employed as part of a tail lamp provided to a rear end section of the vehicle in the vehicle front-rear direction, or as part of a headlamp provided to a front end section in the vehicle front-rear direction. In the present exemplary embodiment, the vehicle lamp 10 is disposed with its length direction running substantially along the vehicle width direction; however the present invention is not limited thereto. For example, the vehicle lamp of the present invention may be disposed with its length direction running substantially along the vehicle up-down direction, or may be disposed with length direction running in a direction intersecting with the vehicle width direction.

The entire contents of the disclosure of Japanese Patent Application No. 2014-068030, filed on Mar. 28, 2014, are incorporated by reference in the present specification.

All publications, patent applications and technical standards mentioned in the present specification are incorporated by reference in the present specification to the same extent as if the individual publication, patent application, or technical standard was specifically and individually indicated to be incorporated by reference.

What is claimed is:

1. A vehicle lamp, comprising:
a light source;
a light guiding member that is configured by an elongated member with light transmitting properties, at which light from the light source is incident through one length direction end face, and that emits light from the light source from an emission face running along the length direction;
a plurality of prism portions that are provided on an opposite side of the light guiding member from the emission face, that are disposed in a row along the length direction, and that reflect light from the light source that is incident to the light guiding member toward the emission face;
a circular arc shaped section that is formed on the emission face side of the light guiding member, and that is configured with a circular arc shaped cross-section in a direction orthogonal to the light guiding member length direction; and
a polygon shaped section that is formed on the prism portion side of the light guiding member, and that is configured with a polygon shaped cross-section in a direction orthogonal to the light guiding member length direction.

2. The vehicle lamp of claim 1, wherein the plurality of prism portions are configured by a plurality of projections projecting out toward an outer side from a face of the polygon shaped section of the light guiding member on the opposite side from the emission face.

3. The vehicle lamp of either claim 1, wherein the polygon shaped section is configured including a location at which the cross-section is a polygonal shape of six or more sides that has been cut in half as viewed in cross-section from the side.

4. The vehicle lamp of claim 3, wherein:
the circular arc shaped section is configured by a first location at which the cross-section is semicircle shaped as viewed in cross-section from the side; and
the polygon shaped section includes:
a second location at which the cross-section is a hexagonal shape that has been cut in half as viewed in cross-section from the side; and
a connection portion connecting between the second location and the circular arc shaped section.

5. The vehicle lamp of claim 2, wherein:
the projections project out from the face of the polygon shaped section on the opposite side from the emission face toward the outer side in a triangular shape as viewed in plan view; and
a face on a light source side of the projections is set at from 88° to 92° with respect to a optical axis of the light emitted from the light source and incident through the one length direction end face of the light guiding member, and a face on the opposite side of the projections from the light source is set at from 41° to 45° with respect to the optical axis of the light emitted from the light source and incident through the one length direction end face of the light guiding member.

6. The vehicle lamp of claim 1, wherein:
the light sources are respectively disposed at positions facing both length direction ends of the light guiding member; and
the plurality of prism portions are formed symmetrically about a length direction central portion of the light guiding member so as to be arrayed toward both length direction end sides.

7. The vehicle lamp of claim 1, wherein the vehicle lamp is a high mount stop lamp provided at an upper portion side of a rear end section in a vehicle front-rear direction of a vehicle.
